(19) United States
(12) Patent Application Publication
(10) Pub. No.: US 2026/0342083 A1
(43) Pub. Date: Oct. 29, 2026

(54) METHOD AND SYSTEM FOR DISTURBANCE REJECTION IN A GRID-CONNECTED ENERGY STORAGE SYSTEM

(71) Applicant: Fluence Energy, LLC, Arlington, VA (US)

(72) Inventors: Krishna Kumar Anaparthi, Bayern (DE); Hernan R. Perez, Valencia (ES)

(73) Assignee: Fluence Energy, LLC, Arlington, VA (US)

(21) Appl. No.: 19/656,698

(22) Filed: Apr. 23, 2026

Related U.S. Application Data
(60) Provisional application No. 63/794,796, filed on Apr. 25, 2025.

(51) Int. Cl. H02J 3/0014; H02J 3/32; H02J 3/38; H02J 7/00; H02J 7/44; H02J 7/80; H02J 7/90

(52) U.S. Cl. CPC H02J 3/00142; H02J 3/32; H02J 3/381; H02J 7/44; H02J 7/80; H02J 7/855; H02J 7/933; H02J 2207/20

(57) ABSTRACT

An electric energy storage system (BESS) includes multiple energy storage modules, a bus bar, core circuit breakers, and a plant controller. Each energy storage module includes rechargeable electrical energy storage devices, a DC/AC power converter, a grid measurement system, and internal circuit breakers. The modules are connectable to an electric grid via the bus bar and the core circuit breakers. The plant controller is in operative communication with the modules and the core circuit breakers and includes a frequency controller. The controller monitors frequency of electric power on the electric grid and controls frequency of electric power on the bus bar in response to the frequency of the electric power on the grid. The controller thereby preconditions measurement of the electrical grid and/or references a control signal before the signal enters a control loop to minimize control retriggering, reduce oscillatory responses, and enhance BESS transient stability under grid disturbances.

### CROSS-REFERENCE TO RELATED APPLICATIONS

The present application claims the benefit of priority to United States Provisional Application No. 63/794,796 filed on Apr. 25, 2025, which is hereby incorporated by reference in its entirety.

### INTRODUCTION

The concepts described herein relate generally to energy storage systems, and more specifically, to modular energy storage systems that supply electric power to an electric grid.

A modular battery, e.g., a battery energy storage system (BESS) includes multiple units that are selectively interconnected to provide varied levels of storage capacity for electrical energy generated from one or more sources, and supply electrical energy to public and/or private consumer(s) via electric grid(s). The modular energy storage system may be used to store excess power produced by an external power source during periods of reduced demand, and provide additional power to external power consumers during periods of increased demand.

Each modular energy storage system includes an array of units that are connected via one or multiple bus bars. Each unit includes one or multiple rechargeable electrical energy storage enclosures, a power converter, a transformer, a core circuit breaker, and a controller.

Increased penetration of renewable electric power resources has resulted in lower system inertia and short circuit strength of the electric grid that has led to increased and faster deviations in grid parameters, i.e., deviations in active power, reactive power, frequency, or voltage of the electric grid.

Grid operators therefore have been increasingly procuring fast responding services or solutions to provide stable operation of the overall grid.

Undesired dynamic responses are observed when stepped voltage or frequency variations occur from the grid side, which may result in unstable responses or power oscillations, which negatively affect the response of the plant and adversely impact the BESS plant operation and grid code compliance.

### SUMMARY

The concepts described herein provide a plant controller and associated system and/or method for controlling and operating a battery (electric) energy storage system (BESS) in a manner that rejects disturbances occurring on a connected electric grid. The plant controller and associated system and/or method operate to precondition grid measurement and/or reference control signals before the control signals enter control loops. The plant controller thereby prevents or minimizes control retriggering, reduces oscillatory responses, and improves or enhances transient stability of the BESS under grid disturbances.

An aspect of the disclosure may include a battery energy storage system (BESS) that includes a plurality of energy storage modules (cores), a bus bar, a plurality of core circuit breakers, and a plant controller. Each of the energy storage modules includes a plurality of rechargeable electrical energy storage devices, a DC/AC power converter, a grid measurement system, and a plurality of internal circuit breakers. Each of the plurality of energy storage modules is connectable to an electric grid via the bus bar and the plurality of core circuit breakers. The plant controller is in communication with and/or operatively connected to the grid measurement system, the plurality of energy storage modules, and the plurality of core circuit breakers. The plant controller is arranged to operate the BESS. The plant controller includes a frequency controller.

Another aspect of the disclosure may include the plant controller being operative to monitor, via the grid measurement system, active power, reactive power, frequency, or voltage on the electric grid, and control, via the frequency controller, at least one of the DC/AC power converter and the plurality of core circuit breakers to control a frequency of electric power on the bus bar in response.

Another aspect of the disclosure may include the frequency controller being a power oscillation damping controller.

Another aspect of the disclosure may include the frequency controller being a fast frequency response controller.

Another aspect of the disclosure may include the frequency controller being a disturbance rejection filter.

Another aspect of the disclosure may include the grid measurement system being configured to measure a parameter related to at least one of active power, reactive power, frequency, or voltage of the electric grid.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 schematically illustrates an embodiment of a battery energy storage system (BESS) including a plurality of rechargeable energy storage modules, in accordance with the disclosure.

FIGS. 2 and 3 schematically illustrate elements related to a frequency controller for controlling an embodiment of a battery energy storage system (BESS), in accordance with the disclosure.

FIGS. 4A and 4B graphically illustrates aspects of operating for a battery energy storage system (BESS) employing a power oscillation damping (POD) controller without a disturbance rejection (DR) filter, in accordance with the disclosure.

FIGS. 5A and 5B graphically illustrate aspects of operating for a battery energy storage system (BESS) employing a power oscillation damping (POD) controller with a disturbance rejection (DR) filter, in accordance with the disclosure.

FIGS. 6A and 6B graphically illustrate aspects of operating for a battery energy storage system (BESS) employing a fast frequency response (FFR) controller without a disturbance rejection (DR) filter, in accordance with the disclosure.

FIGS. 7A, 7B, and 7C, graphically illustrate aspects of operating for a battery energy storage system (BESS) employing a fast frequency response (FFR) controller with a disturbance rejection (DR) filter, in accordance with the disclosure.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description to provide a thorough understanding of the embodiments disclosed herein, some embodiments may be practiced without some of these details. Moreover, for the purpose of clarity, certain technical material that is understood in the related art has not been described in detail to avoid unnecessarily obscuring the disclosure.

Furthermore, the drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

The following detailed description is merely exemplary in nature and is not intended to limit the application and uses. Furthermore, there is no intention to be bound by any expressed or implied theory presented herein. Throughout the drawings, corresponding reference numerals indicate like or corresponding parts and features.

As used herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality.

The use of ordinals such as first, second and third does not necessarily imply a ranked sense of order, but rather may only distinguish between multiple instances of an act or structure.

All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments.

The term “controller” and related terms such as microcontroller, control, control unit, processor, etc. refer to one or various combinations of Application Specific Integrated Circuit(s) (ASIC), Field-Programmable Gate Array(s) (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning, buffer circuitry and other components, which may be accessed by and executed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example every 100 microseconds during ongoing operation. Alternatively, routines may be executed in response to occurrence of a triggering event. Communication between controllers, actuators and/or sensors may be accomplished using a direct wired point-to-point link, a networked communication link, a wireless link, or another communication link. Communication includes exchanging data signals, including, for example, electrical signals via a conductive medium; electromagnetic signals via air; optical signals via optical waveguides; etc. The data signals may include discrete, analog and/or digitized analog signals representing inputs from sensors, actuator commands, and communication between controllers.

The term ‘signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium.

The terms “calibration”, “calibrated”, and related terms refer to a result or a process that correlates a desired parameter and one or multiple perceived or observed parameters for a device or a system. A calibration as described herein may be reduced to a storable parametric table, a plurality of executable equations or another suitable form that may be employed as part of a measurement or control routine.

A parameter is defined as a measurable quantity that represents a physical property of a device or other element that is discernible using one or more sensors and/or a physical model. A parameter may have a discrete value, e.g., either “1” or “0”, or may be infinitely variable in value.

An energy system may include, for example, any system arranged to generate, transmit, convert, distribute, store, and/or use energy (e.g., electrical energy) and/or associated with any other aspect of energy. As one example, an energy system may include an electric grid. An electric grid may include, for example, an interconnected network for electricity delivery from producers to consumers. An electric grid may include, for example, power stations (e.g., thermal power stations, photovoltaic power stations, solar farms, wind power stations, wind farms, hydroelectric power stations, etc.), substations (e.g., for transforming voltage from higher to lower voltage levels, or from lower to higher voltage levels, or for performing other functions associated with transmitting electrical energy between producers and consumers), electrical power transmission and/or distribution (e.g., transmitting electrical energy from producers to substations, and/or delivering electrical energy from a transmission system to consumers), and/or other elements.

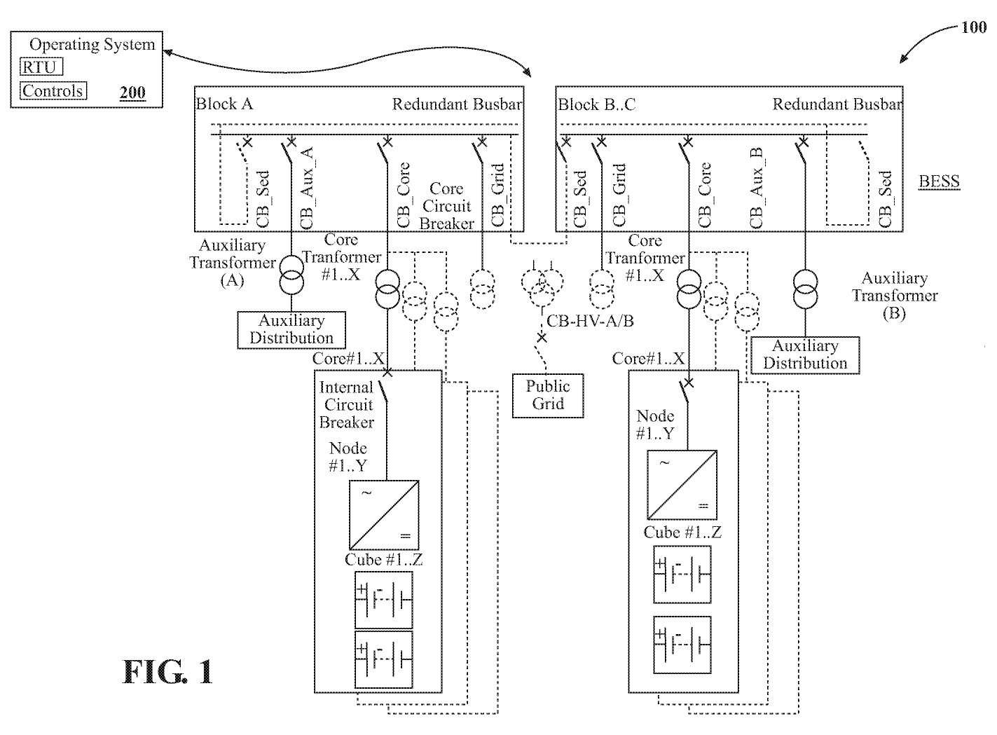

FIG. 1 schematically illustrates an embodiment of a topology for a power plant 100 for supplying electric power to an electric grid. The power plant 100 includes an energy storage system, e.g., a battery energy storage system (BESS), a plant controller (Operating System), and a substation controller (not shown).

The BESS includes a plurality of rechargeable electrical energy storage devices, wherein the BESS is selectively connectable to an electric grid (Public Grid) and an auxiliary system of the BESS (Auxiliary Distribution) by action of the plant controller (Operating System). The BESS is one form of a modular energy storage system having multiple energy storage modules that are interconnected.

The BESS is advantageously arranged in a plurality of arrays (Block A, Block B..C), wherein each of the arrays has a plurality of units including energy storage modules (Core #1…X), and first and second bus bars, circuit breakers, and transformers. The first and second bus bars are redundant, thus enabling electric power flow to various elements of the BESS in accordance with the selected operating mode. Each core has one or multiple nodes, and each node represents a rechargeable electrical energy storage enclosure. Alternatively, a single bus bar may be implemented and employed to enable electric power flow to various elements of the BESS in accordance with the selected operating mode.

As described herein, each of the rechargeable electrical energy storage enclosures or Cubes #1…Z is a single physical container containing one or multiple rechargeable electrical energy storage devices.

One or a plurality of the Cubes are connected to a DC bus to form a Node.

A collection of Nodes is connected to a transformer (Core Transformer #1…X) to form a Core.

A collection of Cores is interconnected to form an array or system.

Each energy storage module (Core #1…X), transformer (Core Transformer #1…X), and core circuit breaker (CB_Core) is controllable by the plant controller (Operating System) to selectively connect the respective Core to the first bus bar. Each energy storage module (Core #1…X) advantageously includes a power converter and internal disconnect circuit breakers, one or multiple sensors, and a thermal management system, in one embodiment. The plurality of rechargeable electrical energy storage enclosures (Cube #1…Z) are connected to a DC bus.

Each of the units of the BESS is selectively electrically connectable to the first bus bar and circuit breakers to supply electric power to an electric grid via the core circuit breaker (CB Core), by action of the plant controller, as detailed with reference to the embodiments illustrated herein.

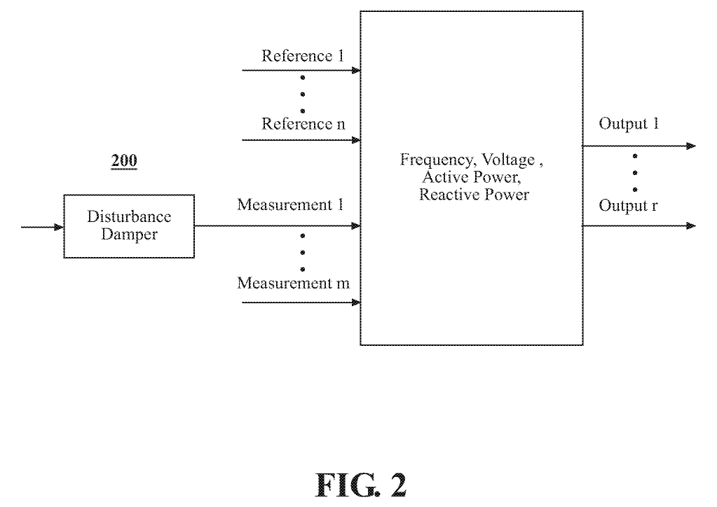

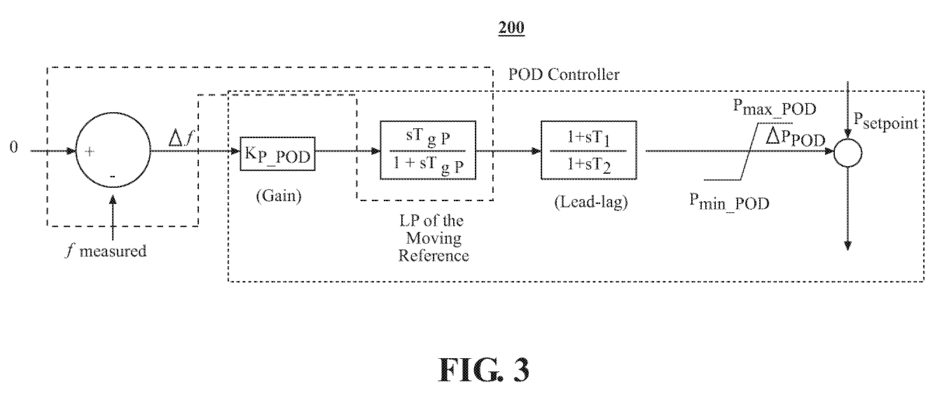

The plant controller includes a frequency controller 200, which is described herein with reference to FIGS. 2 and 3.

The plant controller for the BESS is composed of a remote terminal unit (RTU) and a control system (Controls). The remote terminal unit is the interface to the customer and an external SCADA (Supervisory Control and Data Acquisition) system. The SCADA system is a computer-based system that monitors and controls industrial processes and equipment. The SCADA system uses a combination of hardware and software to collect data from devices and equipment, and then apply operational controls over long distances. The SCADA system may be used to monitor processes, maintain and improve efficiencies, improve quality and profitability, reduce waste, and identify problems and emergencies. Internally, it communicates with the control system and the substation controller by which it operates and monitors the circuit breakers of the power plant 100. It receives operating commands from the customer and converts them into plant controller-specific and site specific commands (e.g. start/stop commands, operation modes, breaker operations…). Additionally, it collects operating values of the power plant 100 from the control system and the substation controller and reports them to the customer and the external SCADA system. While the remote terminal is very project specific by nature, the control system may handle a variety of applications (e.g. frequency control in different markets) and configurations such as different project sizes, power converters and batteries. It processes the commands from the remote terminal, determines the action for each power converter and battery and controls the power plant’s operation at the point of interconnection (POI).

The plant controller, in communication with the substation controller is arranged to monitor and control different elements of the plurality of units, including the respective core circuit breaker (CB Core) and the energy storage module (Core #1…X). This includes selectively electrically connecting the plurality of units to the electric grid via the respective core circuit breaker (CB Core) and the first and second bus bars to transfer electric power, wherein the transfer of electric power may be related to a charging mode or a discharging mode.

Each of the energy storage modules is couplable to an external power source, the electric grid, or a power generator to effect charging, wherein the external power source may originate from solar, wind, geothermal, nuclear, natural gas, coal, diesel fuel, methane, biofuel, or another energy source.

The energy storage modules (Core #1…X) include one of or a plurality of rechargeable electrical energy storage enclosures (Cube #1…Z), which are energy storage devices (or batteries) that include one or more rechargeable electrochemical cells. The rechargeable electrochemical cells may include one or more of various types of batteries, such as lithium-ion batteries, lithium iron phosphate batteries, silver-oxide batteries, nickel-zinc batteries, nickel metal hydride batteries, lead-acid batteries, nickel-cadmium batteries, lithium nickel manganese cobalt oxides (NMC) batteries, lithium nickel cobalt aluminum oxides (NCA) batteries, lithium ion manganese oxide (LMO) batteries, lithium cobalt oxide batteries, fuel cells, or other types of batteries. Alternatively, or in addition, the energy storage devices may be in the form of ultracapacitors, flywheels, fuel cells, etc., without limitation.

The rechargeable electrical energy storage enclosure may have control components associated therewith. The control components may be, for example, configured to individually manage the charge and discharge of each of the batteries. The control components may include, for example, battery management systems (BMS). In some examples, each of the batteries may have a dedicated on-board control component (e.g., a battery management system). The control component for each of the batteries may be implemented by a computing device, and/or may communicate with a central management controller. Additionally, or alternatively, the central management component may manage the charge and discharge of the batteries collectively. The charge and discharge of the batteries of the energy storage modules may be controlled using devices and control algorithms, such as circuits with circuit breaker controls, charge or discharge controllers, charge or discharge regulators, battery regulators, and/or the like, so that each of the batteries may be controlled to be in a state of receiving electricity from a source at a particular rate, in a state of outputting electricity to a load at a particular rate, or in a state of being idle or disconnected.

Each of the energy storage modules (Core #1…X) includes a power converter (or inverter). The power converter may refer to, for example, any system that is operable to convert electric power from one form to another form. For example, the power converter may be configured to convert alternating current (AC) to direct current (DC), convert direct current to alternating current, convert an alternating current at a first frequency and/or magnitude to another alternating current at a second frequency and/or magnitude, convert direct current at a first magnitude to direct current at a second magnitude, etc. In some examples, the power converter may include DC to AC conversion, e.g., using a power inverter, and/or may include AC to DC conversion, e.g., using a rectifier. As one example, the batteries may output electrical energy in the form of direct current, which the power converter may convert into alternating current, e.g., for supplying to a power line or electric grid operating with alternating current. As another example, the power converter may convert alternating current, e.g., received from a power line or electric grid operating with alternating current into direct current for inputting to or charging the batteries. Additionally, or alternatively, the power converter may include AC to AC conversion (via a transformer) and/or may include DC to DC conversion (via a rectifier). The power converter may be configured to convert electrical energy from the batteries into any form for outputting, e.g., to a load, and/or may be configured to convert electrical energy from another source into a suitable form for inputting to or charging of the batteries. For example, the power converter may be used for coupling the batteries to a power bus or an electric grid.

In some examples, the power converter may include a structure or component that may be applicable to the batteries collectively. In some examples, the power converter may include multiple structures or components each of which may be respectively applicable to a corresponding battery of the batteries. In some examples, the power converter may include a structure or component that may be applicable to some of the batteries collectively, and the power converter may include multiple structures or components each of which may be respectively applicable to a corresponding battery of other batteries of the batteries. In some examples, a power conversion system may be used for multiple energy storage modules (cores) collectively (e.g., for converting electrical energy from the multiple energy storage modules (cores) into a desired form for outputting to a load, or for converting electrical energy from a source into a desired form for inputting to or charging the multiple energy storage modules (cores).

The thermal management system is arranged to manage heat transfer to the energy storage modules (cores) to maintain the energy storage modules (cores) within a temperature range that avoids temperature extremes that may affect durability, capacity, and power output thereof. The optimal operating temperature range for lithium batteries is 59°F–77°F (15°C–25°C). This temperature range provides maximum capacity and longevity. Temperatures below 59°F (15°C) will decrease the battery's capacity and power output. Temperatures above 95°F (35°C) will accelerate battery degradation. The range of 68°F to 78°F (20°C to 26°C) provides a stable environment for batteries to perform optimally without being subjected to temperature extremes. Therefore, option c) 68°F to 78°F (20°C to 26°C) is the most suitable temperature range for batteries to work best and avoids temperature extremes that affect durability, capacity, and power output.

The thermal management system may include any type of device configured to remove and/or add heat to the energy storage module (core) and the power converter. The thermal management system may use air, liquid, solid material, gaseous material, and/or any other type of suitable medium or material to remove heat employing conductive heat transfer, convective heat transfer, radiant heat transfer, or another form of heat transfer. In some examples, the thermal management system may include heat sinks and/or thermal management fins. In some examples, the thermal management system may include fans (e.g., for moving air in air-cooling), pumps (e.g., for moving a liquid in liquid-cooling), compressors (e.g., for vapor-compression refrigeration), or any other type of device for thermal management. The thermal management system may have any desired configuration (e.g., shape, size, weight, functionality, etc.), and/or may be disposed, placed, or oriented, or distributed in association with sensor(s), and the power converter. In some examples, the computing device may control the components based on instructions from another computing device (e.g., the energy storage controller device). Additionally, or alternatively, data associated with the energy storage module (core) may be recorded or stored, including, for example, data measured by the sensor(s), data used by the energy storage module (core) (e.g., parameters for controlling the batteries, parameters for controlling the power converter, or parameters for controlling the thermal management system), or any other type of data. The recorded or stored data may be used or processed by the computing device and/or another computing device (e.g., the energy storage controller device) in connection with one or more aspects described herein.

The sensors may be any type of sensor capable of measuring or assessing one or more parameters of the BESS. The sensors may include, for example, voltage sensors, current sensors, frequency sensors (e.g., power bus frequency sensors), power sensors (e.g., for measuring the active power or reactive power of an electric grid), or other types of sensors for obtaining measurements associated with the system 100. The sensors may have any desired configuration (e.g., shape, size, weight, functionality, etc.). The sensors may be configured to obtain measurements of an electric grid, including the power bus. For example, the sensor may be configured to measure the frequency of alternating current as transmitted via the power bus (e.g., the voltage at the bus bar associated with or included in the power bus), or the sensor may be configured to measure the frequency of alternating current as transmitted via the power bus, e.g., the voltage at the bus bar associated with or included in the power bus. The sensors may be coupled to the electric grid in any desired manner, e.g., by electrically coupling to the points of connection of the electric grid. The sensors may send measured data to the energy storage controller device. It is contemplated that the system may employ one or multiple sensors.

Power for operating the thermal management system is supplied via the auxiliary system (Auxiliary Distribution) during a grid outage.

The plant controller is arranged to communicate with and control operation of each of the energy storage modules (core #1…X) employing the remote terminal unit (RTU) and the control system (Controls). The plant controller includes a collection of control processes that are used to monitor and control various elements of the power plant 100. A Market Dispatch Unit (MDU) is responsible for generating active and reactive power dispatch set-points to fulfill the requirements of one or multiple market applications.

The various elements of the BESS are arranged to communicate with each other via a network, including employing interconnected wired and/or wireless communication links.

The control and communication systems are equipped with an uninterruptible power supply (UPS), so that the control system has sufficient power to remain operational during and after a grid outage. Since UPS capacities are limited and the power plant 100 may be required to stay online for several days during a grid outage, the plant controller transitions the BESS into a self-supply mode when a grid outage is detected. In this mode, the BESS itself provides the auxiliary power for the power plant 100, including the UPS, during the grid outage. The self-supply mode provides a stable voltage to the auxiliary system via the auxiliary transformer with only a portion, e.g., a minimum section of the power plant 100, in operation.

In addition, the BESS may refer to any system configured to store energy that is convertible to electric power. The BESS may include the energy storage modules (core) (Battery Cube) being arranged as a centralized system or as a distributed system. The BESS may include one or more energy storage modules. In some examples, the energy storage modules (cores) may be located in a single physical location, such as a site. It is contemplated that the energy storage systems (cores) may include one or multiple energy storage modules (cores), each having one or multiple nodes or rechargeable electrical energy storage enclosures.

The control system may be organized in different control layers. One layer manages all actions on a plant level, and another layer deals with the control of individual Cores, including the control of individual rechargeable electrical energy storage enclosures within the cores. Typical signals that are being sent to the Cores are setpoints (P,Q,V,f) and core operating modes. The core operating modes may include, e.g., Disconnected, grid-forming (GFM) operation, and/or grid-following (GFL) operation. Similarly, each Core reports back to the respective control layer current state information, e.g. State of Charge (SoC), power measurements etc.

The remote terminal may interact with the control system. While the latter is employed to report power plant 100 configurations and connection states of the Cores, the main control interface between the remote terminal and Array is the Plant operating mode, e.g., GFL, and GFM.

### Description of the operating modes

In the Offline mode, the power plant 100 and its components will be brought into Disconnected Operation Mode.

In the Standby mode, the power plant 100 and its components will be brought into Standby Operation Mode. The Cores will need to be connected to the Main Grid.

In the Grid Following mode (GFL), the power plant 100 and its components will be brought into the Grid-Following Operation Mode with the option to perform steady-state secondary control. The Cores will need to be connected to the Main Grid.

In the Grid Forming modes (GFM), the voltage and frequency reference points are propagated from the Array module down to each Core and Node module. In every application, though, the control strategy on the plant level (Array) is different and in combination with the different electrical network configurations on each Core, there is a need to introduce a new way of defining how the Array module needs to operate.

In the Grid Forming Droop P/Q mode, the power plant 100 and its components will be brought into the Grid-Forming Droop Operation Mode and the steady-state secondary control on the plant level will be set to active and reactive power control. The Cores will need to be connected to the Main Grid.

In the Grid Forming Droop mode, the power plant 100 and its components will be brought into the Grid-Forming Droop Operation Mode and the steady-state secondary control on the plant level will be disabled. The Cores will need to be connected to the Main Grid.

In the Grid Forming Isochronous mode, the power plant 100 and its components will be brought into the Grid-Forming Droop Operation Mode and the steady-state secondary control on the plant level will be set to frequency and voltage control. The Cores will need to be connected to the Main Grid.

In the Grid Forming Inertia mode, the power plant 100 and its components will be brought into the Grid-Forming Inertia Operation Mode and the steady-state secondary control on the plant level will be set to active and reactive power control. The Cores will need to be connected to the Main Grid.

Operation of the BESS via the plant controller (F.OS) in the various operating modes may include all or a portion of the BESS being connected to a main, external, or public grid to transfer electric power therebetween in the grid following mode, or one of the grid forming modes.

Operation of the BESS via the plant controller (F.OS) in the various operating modes may include all or a portion of the BESS being connected to an internal or auxiliary grid to transfer electric power in the self-supply mode and/or the black-start mode.

Operation of the BESS via the plant controller in the various operating modes may include all or a portion of the BESS being disconnected from the main grid and the auxiliary grid, and/or being in the standby mode.

A Core, in terms of electrical components, is connected over a circuit breaker to a main electrical circuit/grid which is part of the public grid. However, in Grid-Forming applications there may be more than one electrical circuit to which a Core may be connected (like auxiliary, critical loads, etc.). Both the Core and the Array modules will need to monitor the state of a Core’s electrical connection, as it is essential for the operation of a Power Capacity Manager (PCM). This creates the need for a definition of a list of possible electrical networks that a Core may implement and which will define the way it is going to be operated. The electrical networks include a main grid network, an auxiliary grid network, and a disconnected network, with each of the cores being assigned to one of the electrical networks. The RTU and substation controller assign permission states to the cores based upon whether the respective core is assigned to the main grid network, the auxiliary grid network, or the disconnected network. The assigned permission state determines the actual operation mode of the core and its nodes, with the circuit breakers being controlled based thereon.

As described herein with reference to FIGS. 2 and 3, the battery energy storage system (BESS) includes a plurality of energy storage modules (cores), a bus bar, a plurality of core circuit breakers, and a plant controller, wherein each of the energy storage modules includes a plurality of rechargeable electrical energy storage devices, a DC/AC power converter, a grid measurement system, and a plurality of internal circuit breakers. The plant controller is in communication with and operatively connected to the plurality of energy storage modules and the plurality of core circuit breakers.

The plant controller is in communication with a grid measurement system, which is configured to measure a parameter related to at least one of active power, reactive power, frequency, or voltage of the electric grid.

The plant controller includes the frequency controller 200. The plant controller is operative to monitor, via the sensor, a frequency of electric power on the electric grid, and control, via the frequency controller 200, at least one of the DC/AC power converter and the plurality of core circuit breakers to control one or more of the active power, reactive power, frequency, or voltage of the electric power on the bus bar in response to the respective active power, reactive power, frequency, or voltage of the electric power on the electric grid.

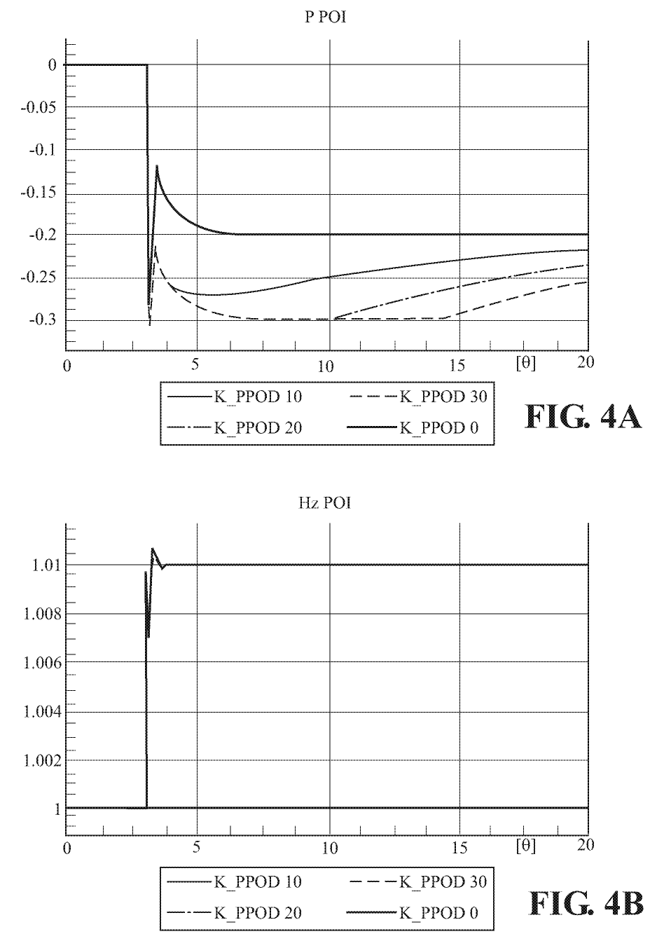

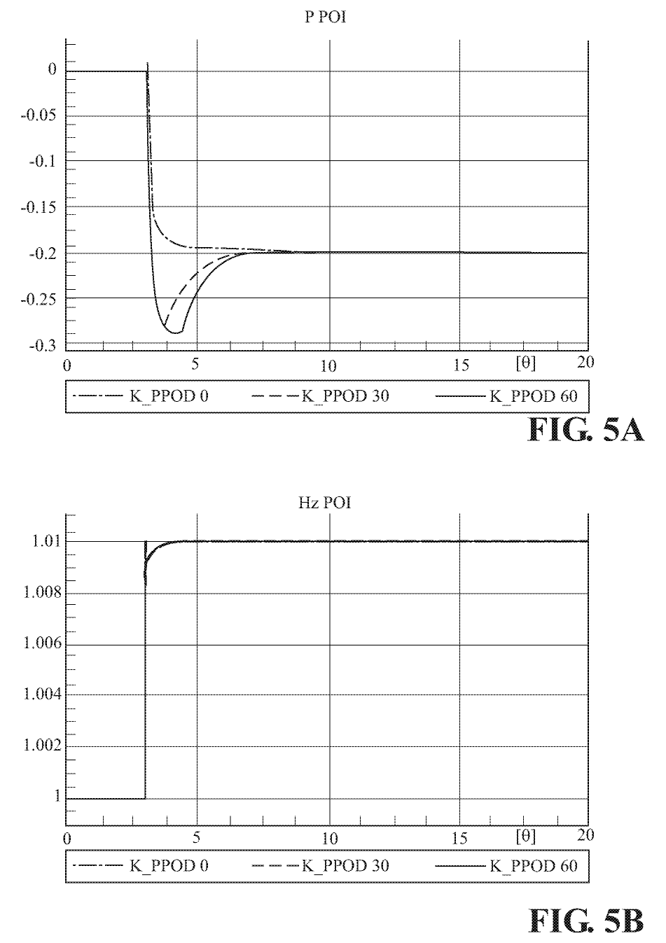

In one embodiment, the frequency controller 200 is a power oscillation damping controller (shown in FIG. 3). A power oscillation damping (POD) controller is a device or control system that is designed to actively suppress low-frequency power oscillations in an electrical grid by adjusting power flow to dampen these oscillations, thereby improving overall system stability and preventing potential blackouts; essentially, it acts like a shock absorber for the power grid by counteracting fluctuations in power generation and transmission. In operation, the POD controller monitors grid conditions and actively injects or absorbs power to counteract power swings, particularly during inter-area oscillations where large power transfers occur between different regions of the grid (shown in FIGS. 4A, 4B, 5A, and 5B, ). Often, POD functionality is integrated into Flexible AC Transmission Systems (FACTS) like Static Var Compensators (SVCs) or Thyristor Controlled Series Capacitors (TCSC) which can rapidly adjust reactive power to damp oscillations. The control strategy of the POD controller includes using feedback signals like voltage, power flow, and frequency measurements to determine the appropriate control actions to damp oscillations.

The POD frequency controller 200 is depicted in FIG. 3 and includes the following elements:
f – frequency in per unit (pu)
Kp_POD – Active Power POD gain
sTgP – Washout Time constant
LP – Low Pass
sT1 – Lead time constant
sT2 – Lag time constant
Pmax_POD – Upper limit of POD
Pmin_POD – Lower limit of POD
PPOD – delta power injection of POD
Psetpoint – final power injection of the controller

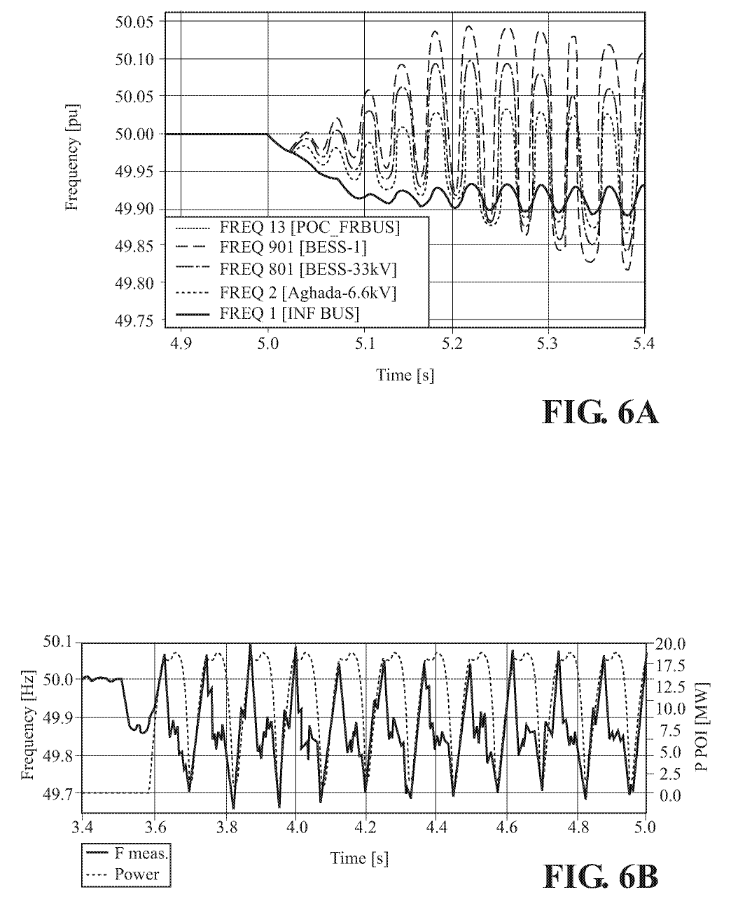

In one embodiment, the frequency controller 200 is a fast frequency response (FFR) controller. A fast frequency response controller is a system designed to rapidly adjust power generation or load within a power grid, typically within a timeframe of 2 seconds or less, to correct imbalances between supply and demand and maintain stable system frequency, essentially acting as a quick-acting stabilizer against sudden fluctuations in the grid; this is often achieved using technologies like battery energy storage systems or advanced inverter controls in renewable energy sources like solar and wind. The function includes quickly responding to changes in grid frequency by adjusting power output to maintain stability, with a response time that is usually within a couple of seconds (shown in FIGS. 6A and 6B).

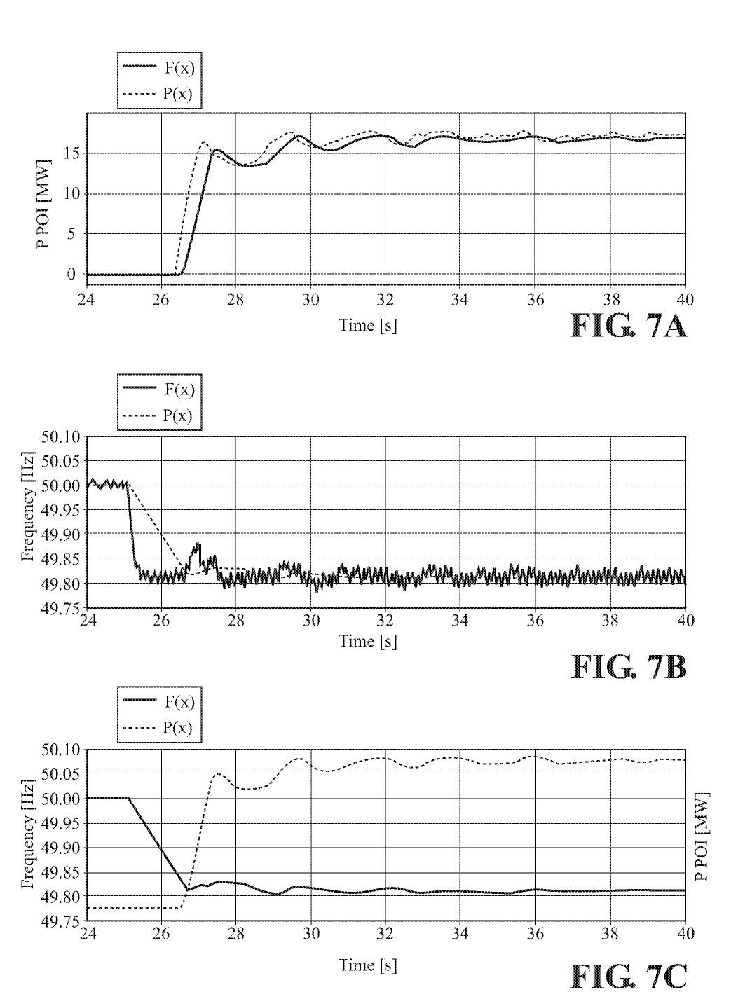

In one embodiment, the frequency controller 200 is a disturbance rejection filter having a signal-conditioning architecture with flexible integration across multiple control paths. A disturbance rejection filter and/or controller is a type of control system designed specifically to minimize the impact of external disturbances on the output of a system, essentially actively compensating for unwanted fluctuations or noise by actively adjusting the control signal to maintain the desired system behavior, even when faced with these disturbances (shown in FIGS. 7A, 7B, and 7C, ). The disturbance rejection filter aims to keep the system output closely aligned with the desired setpoint despite external influences. In operation, the primary goal is to identify and counteract disturbances that might affect the system, such as fluctuations in temperature, pressure, or load changes, by adjusting the control input accordingly. Designing a disturbance rejection filter often involves analyzing the frequency spectrum of the disturbances to tailor the filter characteristics to effectively reject those specific frequencies. In one embodiment, the disturbance rejection filter includes Active Disturbance Rejection Control (ADRC), which uses an observer to estimate the disturbance and then actively cancels it out through the control signal. The ADRC specifically operates to prepare in advance or precondition grid measurement and/or reference control signals before the signals enter control loops and thereby minimizes control retriggering, reduces oscillatory responses, and improves transient stability under grid disturbances.

In one embodiment, the disturbance rejection filter includes a Proportional-Integral-Derivative (PID) controller with specific tuning. In such an embodiment, the disturbance rejection filter operates by adjusting the integral gain of a PID controller, and can become more effective at rejecting disturbances with a steady-state error.

The disturbance rejection (DR) filter functions to avoid retriggering of controls due to aggressive reactions to the PPM/BESS response in case of extreme contingency events from the power system, thus facilitating a fast transient recovery from the inclusion of disturbed signals to the inner control loops.

The frequency controller 200 may include one of or various combinations of the power oscillation damping controller, the fast frequency response controller, and/or the disturbance rejection filter.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may generally be referred to herein as a “module” or “system”. Furthermore, the present disclosure may take the form of a computer program product embodied in a tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in a combination of one or more programming languages.

Elements of the system that is described herein may be implemented in a cloud computing environment. In this description and the following claims, “cloud computing” may be defined as a model for enabling ubiquitous, convenient, on-demand network access to a shared pool of configurable computing resources (e.g., networks, servers, storage, applications, and services) that may be rapidly provisioned via virtualization and released with minimal management effort or service provider interaction, and then scaled accordingly. A cloud model may be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. An electric energy storage system (BESS), comprising:
a plurality of energy storage modules (cores), a bus bar, a plurality of core circuit breakers, and a plant controller;
wherein each of the energy storage modules includes a plurality of rechargeable electrical energy storage devices, a DC/AC power converter, a grid measurement system, and a plurality of internal circuit breakers;
wherein each of the plurality of energy storage modules is connectable to an electric grid via the bus bar and the plurality of core circuit breakers;
wherein the plant controller is in communication with and is operatively connected to the plurality of energy storage modules and the plurality of core circuit breakers;
wherein the plant controller includes a frequency controller; and
wherein the plant controller is operative to:
monitor, via the grid measurement system, a frequency of electric power on the electric grid, and
control, via the frequency controller, at least one of the DC/AC power converter and the plurality of core circuit breakers to control a frequency of electric power on the bus bar in response to the frequency of the electric power on the electric grid to precondition measurement of the electrical grid and/or reference a control signal before the control signal enters a control loop and thereby minimize control retriggering, reduce oscillatory responses, and enhance transient stability of the BESS under electrical grid disturbances.

2. The electric energy storage system (BESS) of claim 1, wherein the frequency controller includes a power oscillation damping (POD) controller.

3. The electric energy storage system (BESS) of claim 2, wherein the POD controller is configured to monitor conditions of the electric grid and actively inject or absorb power to counteract power swings.

4. The electric energy storage system (BESS) of claim 2, wherein the POD controller is configured to counteract power swings during inter-area oscillations where large power transfers occur between different regions of the electric grid.

5. The electric energy storage system (BESS) of claim 4, wherein the POD controller is programmed with a control strategy including using a feedback signal to determine a control action to damp the inter-area oscillations.

6. The electric energy storage system (BESS) of claim 1, wherein the frequency controller comprises a fast frequency response controller.

7. The electric energy storage system (BESS) of claim 6, wherein the fast frequency response controller is configured to respond to changes in frequency of the electric grid by adjusting power output to maintain stability, with a response time within two seconds.

8. The electric energy storage system (BESS) of claim 1, wherein the frequency controller includes a disturbance rejection filter.

9. The electric energy storage system (BESS) of claim 8, wherein the disturbance rejection filter includes Active Disturbance Rejection Control (ADRC) configured to estimate an external disturbance and actively cancel out the disturbance via actively adjusting the control signal.

10. The electric energy storage system (BESS) of claim 8, wherein the disturbance rejection filter includes a Proportional-Integral-Derivative (PID) controller, and wherein the disturbance rejection filter is configured to adjust integral gain of the PID controller to reject the disturbance having a steady-state error.

11. The electric energy storage system (BESS) of claim 1, wherein the grid measurement system is configured to measure a parameter related to at least one of active power, reactive power, frequency, or voltage of the electric grid.

12. A plant controller in communication with and operatively connected to an electric energy storage system (BESS) having a plurality of energy storage modules connectable to an electric grid via a bus bar and a plurality of core circuit breakers, the plant controller comprising:
a frequency controller;
the plant controller is in communication with and is operatively connected to the plurality of energy storage modules and the plurality of core circuit breakers;
wherein each of the energy storage modules includes a plurality of rechargeable electrical energy storage devices, a DC/AC power converter, a grid measurement system, and a plurality of internal circuit breakers; and
wherein the plant controller is configured to:
monitor, via the grid measurement system, a frequency of electric power on the electric grid, and
control, via the frequency controller, at least one of the DC/AC power converter and the plurality of core circuit breakers to control a frequency of electric power on the bus bar in response to the frequency of the electric power on the electric grid to precondition measurement of the electrical grid and/or reference a control signal before the control signal enters a control loop and thereby minimize control retriggering, reduce oscillatory responses, and enhance transient stability of the BESS under electrical grid disturbances.

13. The plant controller of claim 12, wherein the frequency controller includes a power oscillation damping (POD) controller.

14. The plant controller of claim 13, wherein the POD controller is configured to monitor conditions of the electric grid and actively inject or absorb power to counteract power swings.

15. The plant controller of claim 13, wherein the POD controller is configured to counteract power swings during inter-area oscillations where large power transfers occur between different regions of the electric grid, and wherein the POD controller is programmed with a control strategy including using a feedback signal to determine a control action to damp the inter-area oscillations.

16. The plant controller of claim 12, wherein the frequency controller comprises a fast frequency response controller.

17. The plant controller of claim 16, wherein the fast frequency response controller is configured to respond to changes in frequency of the electric grid by adjusting power output to maintain stability, with a response time within two seconds.

18. The plant controller of claim 12, wherein the frequency controller includes a disturbance rejection filter.

19. The plant controller of claim 18, wherein the disturbance rejection filter includes Active Disturbance Rejection Control (ADRC) configured to estimate an external disturbance and actively cancel out the disturbance via actively adjusting the control signal.

20. The plant controller of claim 18, wherein the disturbance rejection filter includes a Proportional-Integral-Derivative (PID) controller, and wherein the disturbance rejection filter is configured to adjust integral gain of the PID controller to reject the disturbance having a steady-state error.
